(19) United States
(12) Patent Application Publication
(10) Pub. No.: US 2023/0308919 A1
(43) Pub. Date: Sep. 28, 2023

(54) QoE MEASUREMENT REPORT DELIVERY IN SPLIT-RAN ARCHITECTURE

(71) Applicant: Telefonaktiebolaget LM Ericsson (publ), Stockholm (SE)

(72) Inventors: Filip Barac, Huddinge (SE); Johan Rune, Lidingö (SE); Ali Parichehrehteroujeni, Linköping (SE); Luca Lunardi, Genoa (IT); Cecilia Eklöf, Täby (SE); Angelo Centonza, Torrenueva Costa (ES)

(21) Appl. No.: 18/013,925

(22) PCT Filed: Jun. 29, 2021
(86) PCT No.: PCT/SE2021/050642

§ 371 Date: Dec. 30, 2022

Related U.S. Application Data
(60) Provisional application No. 63/047,990, filed on Jul. 3, 2020.

(51) Int. Cl. H04W 24/10; H04L 41/5067

(52) U.S. Cl. CPC H04W 24/10; H04L 41/5067; H04W 88/085

(57) ABSTRACT

Systems and methods are disclosed that relate to Quality of Experience (QoE) measurement reporting in a cellular communications system having a split, or distributed, Radio Access Network (RAN) architecture. In one embodiment, a method performed in a RAN having a distributed RAN architecture comprises, at a control plane part of a central unit (CU-CP) of a base station of the RAN, sending one or more first messages to a user plane part of the central unit (CU-UP) to setup or modify one or more bearers and sending one or more second message to a distributed unit (DU) of the base station to setup or modify the one or more bearers.

### RELATED APPLICATIONS

This application claims the benefit of provisional patent application serial number 63/047,990, filed Jul. 3, 2020, the disclosure of which is hereby incorporated herein by reference in its entirety.

### TECHNICAL FIELD

The present disclosure relates to Quality of Experience (QoE) measurement reporting in a cellular communications system.

### BACKGROUND

The overall architecture of the Next Generation Radio Access Network (NG-RAN) is described in Third Generation Partnership Project (3GPP) Technical Specification (TS) 38.401 V16.1.0, Section 6.1.1, which is reproduced below.

### *****Start 3GPP TS 38.401 V16.1.0, Section 6.1.1*****

### 6.1.1 Overall Architecture of NG-RAN

### [Reproduced Herein as FIG. 1]

### FIG. 6.1-1: Overall architecture

The NG-RAN consists of a set of gNBs connected to the 5GC through the NG interface.

NOTE: As specified in 38.300 [2], NG-RAN could also consists of a set of ng-eNBs, an ng-eNB may consist of an ng-eNB-CU and one or more ng-eNB-DU(s). An ng-eNB-CU and an ng-eNB-DU is connected via W1 interface. The general principle described in this section also applies to ng-eNB and W1 interface, if not explicitly specified otherwise.

An gNB can support FDD mode, TDD mode or dual mode operation.

gNBs can be interconnected through the Xn interface.

A gNB may consist of a gNB-CU and one or more gNB-DU(s). A gNB-CU and a gNB-DU is connected via F1 interface.

One gNB-DU is connected to only one gNB-CU.

NOTE: In case of network sharing with multiple cell ID broadcast, each Cell Identity associated with a subset of PLMNs corresponds to a gNB-DU and the gNB-CU it is connected to, i.e. the corresponding gNB-DUs share the same physical layer cell resources.

NOTE: For resiliency, a gNB-DU may be connected to multiple gNB-CUs by appropriate implementation. NG, Xn and F1 are logical interfaces.

For NG-RAN, the NG and Xn-C interfaces for a gNB consisting of a gNB-CU and gNB-DUs, terminate in the gNB-Cu. For EN-DC, the S1-U and X2-C interfaces for a gNB consisting of a gNB-CU and gNB-DUs, terminate in the gNB-CU. The gNB-CU and connected gNB-DUs are only visible to other gNBs and the 5GC as a gNB. A possible deployment scenario is described in Annex A.

The node hosting user plane part of NR PDCP (e.g. gNB-CU, gNB-CU-UP, and for EN-DC, MeNB or SgNB depending on the bearer split) shall perform user inactivity monitoring and further informs its inactivity or (re)activation to the node having C-plane connection towards the core network (e.g. over E1, X2). The node hosting NR RLC (e.g. gNB-DU) may perform user inactivity monitoring and further inform its inactivity or (re)activation to the node hosting control plane, e.g. gNB-CU or gNB-CU-CP.

UL PDCP configuration (i.e. how the UE uses the UL at the assisting node) is indicated via X2-C (for EN-DC), Xn-C (for NG-RAN) and FI-C. Radio Link Outage/Resume for DL and/or UL is indicated via X2-U (for EN-DC), Xn-U (for NG-RAN) and FI-U.

The NG-RAN is layered into a Radio Network Layer (RNL) and a Transport Network Layer (TNL).

The NG-RAN architecture, i.e. the NG-RAN logical nodes and interfaces between them, is defined as part of the RNL.

For each NG-RAN interface (NG, Xn, F1) the related TNL protocol and the functionality are specified. The TNL provides services for user plane transport, signalling transport.

In NG-Flex configuration, each NG-RAN node is connected to all AMFs of AMF Sets within an AMF Region supporting at least one slice also supported by the NG-RAN node. The AMF Set and the AMF Region are defined in 3GPP TS 23.501 [3].

If security protection for control plane and user plane data on TNL of NG-RAN interfaces has to be supported, NDS/IP 3GPP TS 33.501 [13] shall be applied.

### *****End 3GPP Ts 38.401 V16.1.0, Section 6.1.1*****

The overall architecture for separation of the control plane part (gNB-CU-CP) of the next generation Node B (gNB) Central Unit (CU), which is denoted herein as a gNB-CU, and the user plane part (gNB-CU-UP) of the gNB-CU is described in 3GPP TS 38.401 V16.1.0, Section 6.1.2, which is reproduced below.

### *****Start 3GPP Ts 38.401 V16.1.0, Section 6.1.2*****

The overall architecture for separation of gNB-CU-CP and gNB-CU-UP is depicted in FIG. 6.1.2-1.

### [Reproduced Herein as FIG. 2]

### FIG. 6.1.2-1. Overall architecture for separation of gNB-CU-CP and gNB-CU-UP

A gNB may consist of a gNB-CU-CP, multiple gNB-CU-UPs and multiple gNB-DUs;
The gNB-CU-CP is connected to the gNB-DU through the F1-C interface;
The gNB-CU-UP is connected to the gNB-DU through the F1-U interface;
The gNB-CU-UP is connected to the gNB-CU-CP through the E1 interface;
One gNB-DU is connected to only one gNB-CU-CP;
One gNB-CU-UP is connected to only one gNB-CU-CP;

NOTE 1: For resiliency, a gNB-DU and/or a gNB-CU-UP may be connected to multiple gNB-CU-CPs by appropriate implementation.
One gNB-DU can be connected to multiple gNB-CU-UPs under the control of the same gNB-CU-CP;
One gNB-CU-UP can be connected to multiple DUs under the control of the same gNB-CU-CP;

NOTE 2: The connectivity between a gNB-CU-UP and a gNB-DU is established by the gNB-CU-CP using Bearer Context Management functions.

NOTE 3: The gNB-CU-CP selects the appropriate gNB-CU-UP(s) for the requested services for the UE. In case of multiple CU-UPs they belong to same security domain as defined in TS 33.210 [18].

NOTE 4: Data forwarding between gNB-CU-UPs during intra-gNB-CU-CP handover within a gNB may be supported by Xn-U.

### *****End 3GPP TS 38.401 V16.1.0, Section 6.1.2*****

Quality of Experience (QoE) measurements have been specified for Long Term Evolution (LTE) and Universal Mobile Telecommunications System (UMTS). The purpose of these application layer measurements is to measure the end user experience when using certain applications. Currently, QoE measurements for streaming services and for Mobility Telephony Service for Internet Protocol Multimedia Subsystem (MTSI) services are supported in LTE.

The solutions in LTE and UMTS are similar with the overall principles as follows. QoE measurement collection enables configuration of application layer measurements in the UE and transmission of QoE measurement result files by means of Radio Resource Control (RRC) signaling. Application layer measurement configuration received from Operations and Management (O&M) or the Core Network (CN) is encapsulated in a transparent container, which is forwarded to the User Equipment (UE) in a downlink RRC message. Application layer measurement results received from the UE’s higher layer are encapsulated in a transparent container and sent to the network in an uplink RRC message. The measurement result container is forwarded to a Trace Collector Entity (TCE). The RRC signaling flow for QoE measurements in LTE is shown in FIG. 3.

In 3GPP release 17, a new study item for “Study on NR QoE management and optimizations for diverse services” for New Radio (NR) has been approved. The purpose of the study item is to study solutions for QoE management in NR. QoE management in NR will not just collect the experience parameters of streaming services but also consider the typical performance requirements of diverse services (e.g., Augmented Reality (AR) / Virtual Reality (VR) and Ultra-Reliable Low-Latency Communication (URLLC)). Based on requirements of services, the NR study will also include more adaptive QoE management schemes that enable network intelligent optimization to satisfy user experience for diverse services.

QoE measurements may be initiated towards the Radio Access Network (RAN) in a management-based manner, i.e., from an O&M node in a generic way for a group of UEs, or they may also be initiated in a signaling-based manner, i.e., initiated from the CN to the RAN. The configuration of a QoE measurement includes the measurement details, which are encapsulated in a container that is transparent to the RAN.

When initiated via the CN, the QoE measurement configuration is directed towards a specific UE. The “TRACE REQUEST” is realized as an S1AP message in LTE, which carries the configuration information for the measurement details and information that indicates the TCE to which the collected QoE measurements should be sent.

The RAN is not aware of when a streaming session is ongoing in the UE and is also not aware of when the QoE measurements are ongoing. It is important for the client analyzing the QoE measurements that the whole session is measured. It is an implementation decision when the RAN stops the measurements. Typically, it is done when the UE has moved outside the measurement area.

It is beneficial that, if there is a streaming session, the UE would keep the QoE measurement for the whole session, even during a handover situation. It has been concluded during a 3GPP study that fragmented QoE reports are of little use.

In LTE the message MeasReportAppLayer is used for transmission of the QoE measurement result file, see the following extract from the RRC specification TS 36.331 V16.0.0:

### *****Start Excerpt From 3GPP TS 36.331 V16.0.0*****

### MeasReportAppLayer

The MeasReportAppLayer message is used for sending application layer measurement report.
Signalling radio bearer: SRB4
RLC-SAP: AM
Logical channel: DCCH
Direction: UE to E-UTRAN

MeasReportAppLayer message
-- ASN1START
MeasReportAppLayer-r15 ::= SEQUENCE {
criticalExtensions CHOICE {
measReportAppLayer-r15 MeasReportAppLayer-r15-IEs,
criticalExtensionsFuture SEQUENCE {}
}
}
MeasReportAppLayer-r15-IEs ::= SEQUENCE {
measReportAppLayerContainer-15 OCTET STRING (SIZE(1..8000)) OPTIONAL,
serviceType-15 ENUMERATED {qoe, goemtsi, spare6, spare5, spare4, spare3,
spare2, spare1} OPTIONAL,
nonCriticalExtension MeasReportAppLayer-v1590-IEs OPTIONAL
}
MeasReportAppLayer-v1590-IEs ::= SEQUENCE {
lateNonCriticalExtension OCTET STRING OPTIONAL,
nonCriticalExtension SEQUENCE {} OPTIONAL
}
-- ASN1STOP

MeasReportAppLayer field descriptions
measReportAppLayerContainer
The field contains container of application layer measurements, see Annex L (normative) in TS 26.247 [90] and clause 16.5 in TS 26.114 [99].
serviceType
Indicates the type of application layer measurement. Value qoe indicates Quality of Experience Measurement Collection for streaming services, value qoemtsi indicates Quality of Experience Measurement Collection for MTSI.

### *****End Excerpt From 3GPP TS 36.331 V16.0.0*****

### SUMMARY

Systems and methods are disclosed that relate to Quality of Experience (QoE) measurement reporting in a cellular communications system having a split, or distributed, Radio Access Network (RAN) architecture. In one embodiment, a method performed in a RAN having a distributed RAN architecture comprises, at a control plane part of a central unit (CU-CP) of a base station of the RAN, sending one or more first messages to a user plane part of the central unit (CU-UP) to setup or modify one or more bearers and sending one or more second message to a distributed unit (DU) of the base station to setup or modify the one or more bearers. The method further comprises, at the CU-UP, receiving the one or more first messages from the CU-CP. The method further comprises, at the DU, receiving the one or more second messages and sending one or more QoE measurement reports to the CU-UP via the one or more bearers. The method further comprises, at the CU-UP, receiving the one or more QoE measurement reports from the DU and forwarding the one or more QoE measurement reports to the CU-CP, another network node, or both the CU-CP and another network node.

In one embodiment, the one or more bearers are one or more bearers that are dedicated for QoE measurement reporting.

In one embodiment, the one or more bearers are not dedicated for QoE measurement reporting. In one embodiment, receiving the one or more QoE measurement reports at the CU-UP comprises receiving the one or more QoE measurement reports at the CU-UP via one or more Protocol Data Units (PDUs) of a PDU type that is dedicated for QoE measurement reporting. In another embodiment, receiving the one or more QoE measurement reports at the CU-UP comprises receiving the one or more QoE measurement reports at the CU-UP via one or more PDUs of a PDU type that is not dedicated for QoE measurement reporting. In one embodiment, the one or more PDUs comprise an indication that the one or more PDUs comprise one or more QoE measurement reports.

In one embodiment, the one or more PDUs comprise an indication of how the one or more QoE measurement reports are to be treated by the CU-UP.

In one embodiment, the one or more PDUs comprise an indication of whether the CU-UP is to forward the one or more QoE measurement reports to the CU-CP, another network node, or both the CU-CP and another network node.

Embodiments of a method performed by a CU-CP of a base station of a RAN having a distributed RAN architecture are also disclosed. In one embodiment, the method comprises sending one or more first messages to a CU-UP to setup or modify one or more bearers that are dedicated for QoE measurement reporting.

In one embodiment, the one or more first messages comprise a bearer setup message or a bearer modification message for a respective bearer from among the one or more bearers, the bearer setup message or the bearer modification message comprising: (a) an indication that the respective bearer is to be used for QoE measurement reporting, (b) an indication that the respective bearer is to be used for carrying QoE measurement reports of a particular QoE measurement session, (c) an indication that the respective bearer is to be used for carrying QoE measurement reports of a number of QoE measurement sessions, (d) an indication of whether the respective bearer can be used for carrying QoE measurement reports of one or more QoE measurement sessions identified in a list of QoE measurement session identities (IDs), (e) a configuration of one or more Quality of Service (QoS) attributes defined for QoE report delivery over user plane, (f) one or more attributes that control behavior of the CU-UP upon reception of data on the respective bearer used for QoE measurement reporting, (g) one or more attributes that control the behavior of the CU-UP upon suspension of the respective bearer used for QoE measurement reporting, (h) one or more attributes that control the behavior of the CU-UP to, if needed, forward data of the respective bearer used for QoE measurement reporting to another CU-UP controlled by the same CU-CP, or (j) a combination of any two or more of (a) - (h).

In one embodiment, the method further comprises sending one or more second messages to a DU of the base station to setup or modify the one or more bearers that are dedicated for QoE measurement reporting. In one embodiment, the one or more second messages comprise a bearer setup message or a bearer modification message for a respective bearer from among the one or more bearers, the bearer setup message or the bearer modification message comprising: (i) an indication that the respective bearer is to be used for QoE measurement reporting, (ii) an indication that the respective bearer is to be used for carrying QoE measurement reports of a particular QoE measurement session, (iii) an indication that the respective bearer is to be used for carrying QoE measurement reports of a number of QoE measurement sessions, (iv) an indication that the respective bearer is to be used for carrying QoE measurement reports of one or more QoE measurement sessions identified in a list of QoE measurement session IDs, (v) a configuration of one or more QoS attributes defined for QoE report delivery over user plane, (vi) one or more attributes that control behavior of the DU upon reception of data on the respective bearer used for QoE measurement reporting, (vii) one or more attributes that control the behavior of the DU upon suspension of the respective bearer used for QoE measurement reporting, (viii) one or more attributes that control the behavior of the DU to, if needed, forward data of the respective bearer used for QoE measurement reporting to another CU-UP controlled by the same CU-CP, (ix) a combination of any two or more of (i) - (viii).

In one embodiment, the one or more bearers that are dedicated for QoE measurement reporting comprise two or more bearers that are dedicated for QoE measurement reporting for a particular wireless communication device. In one embodiment, the two or more bearers are associated to different QoE measurement report types. In one embodiment, different QoE report types are given different treatment.

In one embodiment, the method further comprises detecting a trigger for setting up the one or more bearers that are dedicated for QoE measurement reporting. Further, sending the one or more first messages to the CU-UP comprises sending the one or more first messages to the CU-UP to setup the one or more bearers that are dedicated for QoE measurement reporting responsive to detecting the trigger. In one embodiment, the trigger is: (a) forwarding a respective QoE measurement configuration to a respective wireless communication device, (b) selecting a wireless communication device for a received management-based QoE measurement configuration, (c) receiving a QoE measurement configuration from OAM or a core network node for a respective wireless communication device, (d) receiving an indication from a respective wireless communication device that a QoE report is ready to be delivered, or (e) receiving a report availability indication from a respective wireless communication device carried over user plane.

In one embodiment, the one or more first messages comprise an indication that the one or more bearers are to be used for carrying QoE measurement reports.

In one embodiment, the one or more first messages comprise an indication that QoE measurement report transfer via at least one of the one or more bearers is to be paused or resumed.

In one embodiment, the one or more first messages comprise an indication of one or more attributes related to QoE measurement report transfer via at least one of the one or more bearers. In one embodiment, the one or more attributes related to QoE measurement transfer comprise priority, pre-emption capability, and/or pre-emption vulnerability.

In one embodiment, the one or more first messages comprise an indication of whether QoE measurement reports received via at least one of the one or more bearers is to be forwarded to the CU-CP or another network entity.

In one embodiment, the CU-CP instructs the CU-UP where to forward QoE measurement reports during setup of an interface between the CU-CP and the CU-UP.

In one embodiment, during setup of an interface between the CU-CP and the CU-UP, the CU-CP receives information that indicates one or more QoE measurement report forwarding alternatives that are supported by the CU-UP.

Corresponding embodiments of a RAN node that implements a CU-CP of a base station of a RAN having a distributed RAN architecture are also disclosed. In one embodiment, the RAN node is adapted to send one or more first messages to a CU-UP to setup or modify one or more bearers that are dedicated for QoE measurement reporting. In another embodiment, a RAN node that implements a CU-CP of a base station of a RAN having a distributed RAN architecture comprises a communication interface and processing circuitry associated with the communication interface. The processing circuitry is configured to cause the RAN node to send one or more first messages to a CU-UP to setup or modify one or more bearers that are dedicated for QoE measurement reporting.

Embodiments of a method performed by a CU-UP of a base station of a RAN having a distributed RAN architecture are also disclosed. In one embodiment, the method comprises receiving one or more first messages from a CU-CP to setup or modify one or more bearers that are dedicated for QoE measurement reporting.

In one embodiment, the one or more first messages comprise a bearer setup message or a bearer modification message for a respective bearer from among the one or more bearers, the bearer setup message or the bearer modification message comprising: (a) an indication that the respective bearer is to be used for QoE measurement reporting, (b) an indication that the respective bearer is to be used for carrying QoE measurement reports of a particular QoE measurement session, (c) an indication that the respective bearer is to be used for carrying QoE measurement reports of a number of QoE measurement sessions, (d) an indication of whether the respective bearer can be used for carrying QoE measurement reports of one or more QoE measurement sessions identified in a list of QoE measurement session IDs (e) a configuration of one or more QoS attributes defined for QoE report delivery over user plane, (f) one or more attributes that control behavior of the CU-UP upon reception of data on the respective bearer used for QoE measurement reporting, (g) one or more attributes that control the behavior of the CU-UP upon suspension of the respective bearer used for QoE measurement reporting, (h) one or more attributes that control the behavior of the CU-UP to, if needed, forward data of the respective bearer used for QoE measurement reporting to another CU-UP controlled by the same CU-CP, or (i) a combination of any two or more of (a) - (h).

In one embodiment, the method further comprises receiving one or more QoE measurement reports from a DU of the base station via at least one of the one or more bearers that are dedicated for QoE measurement reporting and forwarding the one or more QoE measurement reports to the CU-CP, another network node, or both the CU-CP and another network node. In one embodiment, forwarding the one or more QoE measurement reports comprises forwarding the one or more QoE measurement reports via one or more wireless-communication-device-associated messages or via one or more non-wireless-communication-device-associated messages each comprising a list of identifiers that distinguishes between QoE measurement reports for different wireless communication devices and/or a list of measurement session identifiers that distinguishes between QoE measurement reports for a same wireless communication device. In one embodiment, the CU-UP stores the one or more QoE measurement reports, and forwarding the one or more QoE measurement reports comprises forwarding the one or more QoE measurement reports to the CU-CP responsive to a request from the CU-CP.

In one embodiment, the one or more bearers that are dedicated for QoE measurement reporting comprise two or more bearers that are dedicated for QoE measurement reporting for a particular wireless communication device. In one embodiment, the two or more bearers are associated to different QoE measurement report types. In one embodiment, different QoE report types are given different treatment.

In one embodiment, the one or more first messages comprise an indication that the one or more bearers are to be used for carrying QoE measurement reports.

In one embodiment, the one or more first messages comprise an indication that QoE measurement report transfer via at least one of the one or more bearers is to be paused or resumed.

In one embodiment, the one or more first messages comprise an indication of one or more attributes related to QoE measurement report transfer via at least one of the one or more bearers. In one embodiment, the one or more attributes related to QoE measurement transfer comprise priority, pre-emption capability, and/or pre-emption vulnerability.

In one embodiment, the one or more first messages comprise an indication of whether QoE measurement reports received via at least one of the one or more bearers is to be forwarded to the CU-CP or another network entity.

In one embodiment, the CU-UP receives an instruction from the CU-CP about where to forward QoE measurement reports, the instruction being received during setup of an interface between the CU-CP and the CU-UP.

In one embodiment, during setup of an interface between the CU-CP and the CU-UP, the CU-UP sends, to the CU-CP, information that indicates one or more QoE measurement report forwarding alternatives that are supported by the CU-UP.

In one embodiment, the CU-UP provides different treatment to different types of QoE measurement report data.

Corresponding embodiments of a RAN node that implements a CU-UP of a base station of a RAN having a distributed RAN architecture are also disclosed. In one embodiment, the RAN node is adapted to receive one or more first messages from a CU-CP to setup or modify one or more bearers that are dedicated for QoE measurement reporting.

In another embodiment, a RAN node that implements a CU-UP of a base station of a RAN having a distributed RAN architecture comprises a communication interface and processing circuitry associated with the communication interface. The processing circuitry is configured to cause the RAN node to receive one or more first messages from a CU-CP to setup or modify one or more bearers that are dedicated for QoE measurement reporting.

In another embodiment, a method performed by a CU-CP of a base station of a RAN having a distributed RAN architecture comprises sending one or more first messages to a CU-UP to setup or modify one or more bearers and sending one or more second message to a DU of the base station to setup or modify the one or more bearers. QoE measurement reports are transported on the one or more bearers using either: (a) PDUs of a PDU type that is dedicated for QoE measurement reporting or (b) PDUs of a PDU type for which the PDUs comprise an indicator that indicates that the PDUs carry QoE measurement reports.

In one embodiment, the PDUs further comprise an indicator of how the CU-UP is to treat QoE measurement reports carried by the PDUs.

Corresponding embodiments of a RAN node that implements a CU-CP of a base station of a RAN having a distributed RAN architecture are also disclosed. In one embodiment, the RAN node is adapted to send one or more first messages to CU-UP to setup or modify one or more bearers and send one or more second message to a DU of the base station to setup or modify the one or more bearers. QoE measurement reports are transported on the one or more bearers using either: (a) PDUs of a PDU type that is dedicated for QoE measurement reporting or (b) PDUs of a PDU type for which the PDUs comprise an indicator that indicates that the PDUs carry QoE measurement reports.

In one embodiment, the PDUs further comprise an indicator of how the CU-UP (602-n) is to treat QoE measurement reports carried by the PDUs.

In another embodiment, a RAN node that implements a CU-CP of a base station of a RAN having a distributed RAN architecture comprises a communication interface and processing circuitry associated with the communication interface. The processing circuitry is configured to cause the RAN node to send one or more first messages to a CU-UP to setup or modify one or more bearers and send one or more second message to a DU of the base station to setup or modify the one or more bearers. QoE measurement reports are transported on the one or more bearers using either: (a) PDUs of a PDU type that is dedicated for QoE measurement reporting or (b) PDUs of a PDU type for which the PDUs comprise an indicator that indicates that the PDUs carry QoE measurement reports.

In one embodiment, the PDUs further comprise an indicator of how the CU-UP is to treat QoE measurement reports carried by the PDUs.

In one embodiment, a method performed by a CU-UP of a base station of a RAN having a distributed RAN architecture comprises receiving one or more first messages from a CU-CP to setup or modify one or more bearers and receiving one or more QoE measurement reports from a DU of the base station via the one or more bearers, the one or more QoE measurement reports being carried in either: (a) one or more PDUs of a PDU type that is dedicated for QoE measurement reporting or (b) one or more PDUs of a PDU type for which the one or more PDUs comprise an indicator that indicates that the one or more PDUs carry the one or more QoE measurement reports.

In one embodiment, the method further comprises forwarding the one or more QoE measurement reports to the CU-CP, another network node, or both the CU-CP and another network node.

In one embodiment, the one or more PDUs further comprise an indicator of how the CU-UP is to treat QoE measurement reports carried by the PDUs. In one embodiment, the method further comprises forwarding the one or more QoE measurement reports to the CU-CP, another network node, or both the CU-CP and another network node, in accordance with the indicator of how the CU-UP is to treat QoE measurement reports carried by the PDUs.

Corresponding embodiments of a RAN node that implements a CU-UP of a base station of a RAN having a distributed RAN architecture are also disclosed. In one embodiment, the RAN node is adapted to receive one or more first messages from a CU-CP to setup or modify one or more bearers and receive one or more QoE measurement reports from a DU of the base station via the one or more bearers, the one or more QoE measurement reports being carried in either: (a) one or more PDUs of a PDU type that is dedicated for QoE measurement reporting or (b) one or more PDUs of a PDU type for which the one or more PDUs comprise an indicator that indicates that the one or more PDUs carry the one or more QoE measurement reports.

In another embodiment, a RAN node that implements a CU-UP of a base station of a RAN having a distributed RAN architecture comprises a communication interface and processing circuitry associated with the communication interface. The processing circuitry is configured to cause the RAN node to receive one or more first messages from a CU-CP to setup or modify one or more bearers and receive one or more QoE measurement reports from a DU of the base station via the one or more bearers, the one or more QoE measurement reports being carried in either: (a) one or more PDUs of a PDU type that is dedicated for QoE measurement reporting or (b) one or more PDUs of a PDU type for which the one or more PDUs comprise an indicator that indicates that the one or more PDUs carry the one or more QoE measurement reports.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 is a reproduction of FIG. 6.1-1 from Third Generation Partnership Project (3GPP) Technical Specification (TS) 38.401 V16.1.0;

FIG. 2 is a reproduction of FIG. 6.1.2-1 from 3GPP TS 38.401 V16.1.0;

FIG. 3 illustrates the Radio Resource Control (RRC) signaling flow for Quality of Experience (QoE) measurements in Long Term Evolution (LTE);

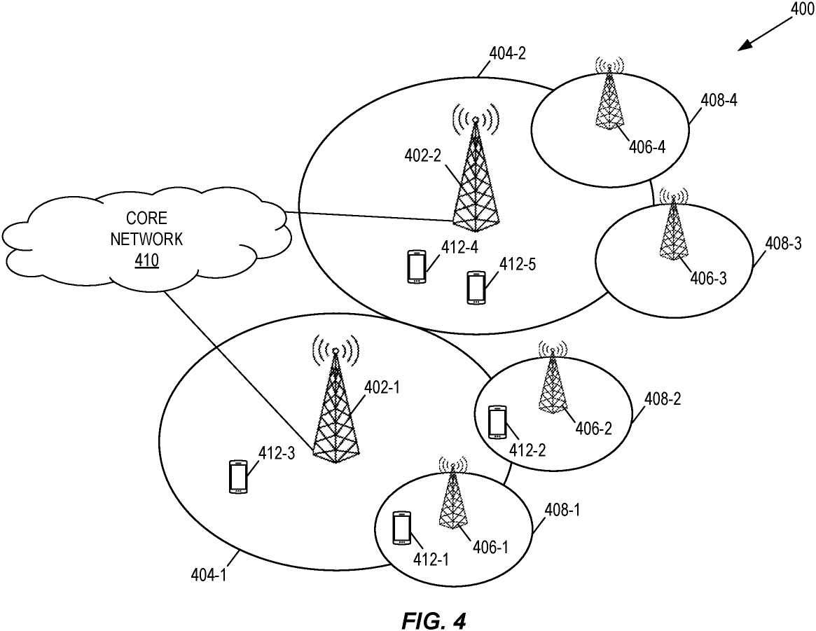

FIG. 4 illustrates one example of a cellular communications system in which embodiments of the present disclosure may be implemented;

FIGS. 5 and 6 illustrate the 3GPP New Radio (NR) Radio Access Network (RAN) split architecture;

FIG. 7 illustrates the operation of a next generation Node B (gNB) Central Unit (CU) Control Plane (CP) part (i.e., a gNB-CU-CP), a gNB CU User Plane (UP) part (i.e., a gNB-CU-UP), and a gNB Distributed Unit (DU) (i.e., a gNB-DU) in accordance with embodiments related to a first aspect of the present disclosure;

FIG. 8 illustrates the operation of a gNB-CU-CP, a gNB-CU-UP, and a gNB-DU in accordance with embodiments related to a second aspect of the present disclosure;

FIGS. 9, 10, and 11 are schematic block diagrams of a RAN node in accordance with embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

The terms “CU”, “DU”, ″CU-CP″, “CU-UP″ herein apply to both the LTE and NR Central Unit (CU) - Distributed Unit (DU) and Control Plane (CP) - User Plane (UP) split architecture comprising e.g. the gNB-CU, gNB-DU, gNB-CU-UP, and gNB-CU-CP in the case of NR and comprising eNB-CU, eNB-DU, eNB-CU-UP, and eNB-CU-CP in the case of LTE.

In case the LTE/NR CU is not split into CU-CP and CU-UP, all considerations herein apply to the gNB-CU or eNB-CU as well.

The proposed solution applies to all scenarios covered in 3GPP Technical Specification (TS) 38.425, where the node hosting the Packet Data Convergence Protocol (PDCP) entity can be either a CU-UP, gNB-CU, or Master eNB (MeNB), while the corresponding node can be a gNB-DU.

The terms “QoE measurement report”, “measurement report” and “report” are used interchangeably herein to refer to the QoE measurement results delivered from the UE to the network.

The terms “special bearer” and “dedicated bearer” are used interchangeably.

All considerations related to Data Radio Bearers (DRBs) / Service Radio Bearers (SRBs) herein apply to both LTE and NR user plane and control plane bearers.

The terms “measurement collection entity” (MCE) and “trace collection entity” (TCE) are used interchangeably.

There currently exist certain challenge(s). It has been proposed that the UE sends a QoE measurement report to the network via the UP by configuring a dedicated radio bearer. Nevertheless, it is not clear how the measurement report delivery for the above two alternatives (i.e., via UP and CP) can be configured and executed in the case of a split RAN architecture, namely in case of: (a) CU-DU split in the RAN and (b) CU-CP - CU-UP split in the RAN.

Certain aspects of the present disclosure and their embodiments may provide solutions to the aforementioned or other challenges. Systems and methods are disclosed herein that provide signaling that enables configuration and execution of QoE measurement report delivery over the UP in a split RAN architecture.

Certain embodiments may provide one or more of the following technical advantage(s). The proposed solution enables configuration and execution QoE measurement report delivery over the UP in a split RAN architecture. Some example advantages of delivering the QoE measurement report over the UP are avoidance of congesting the CP resources due to large measurement reports, as well as faster delivery of measurement reports compared to the transfer over the CP, which, in turn, also enables a faster reaction based on measurement results.

Further advantages in terms of improved reliability for a service(s) / use case(s) and its related QoE measurement reports can be achieved by exploiting the network architecture where e.g., a gNB may be deployed with more than one gNB-CU-UP. As an example, one or more CU-UPs may be used for the purpose of redundancy, increasing the network resilience to send user data including QoE measurement report in case of failure. In another variant, some level of data segregation may be achieved if one or more CU-UPs are dedicated to treat only certain use case(s) and respective QoE measurement reports.

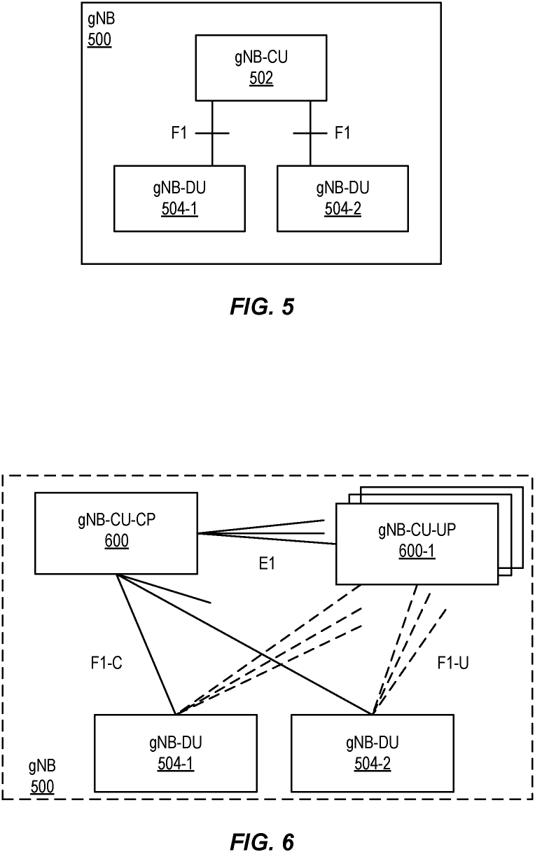

FIG. 4 illustrates one example of a cellular communications system 400 in which embodiments of the present disclosure may be implemented. In the embodiments described herein, the cellular communications system 400 is a 5G system (5GS) including a Next Generation RAN (NG-RAN) and a 5G Core (5GC) or an Evolved Packet System (EPS) including an Evolved Universal Terrestrial Radio Access Network (E-UTRAN) and Evolved Packet Core (EPC); however, the embodiments disclosed herein are not limited thereto. In this example, the RAN includes base stations 402-1 and 402-2, which in the 5GS include NR base stations (gNBs) and optionally next generation eNBs (ng-eNBs) (e.g., LTE RAN nodes connected to the 5GC) and in the EPS include eNBs, controlling corresponding (macro) cells 404-1 and 404-2. The base stations 402-1 and 402-2 are generally referred to herein collectively as base stations 402 and individually as base station 402. Likewise, the (macro) cells 404-1 and 404-2 are generally referred to herein collectively as (macro) cells 404 and individually as (macro) cell 404. The RAN may also include a number of low power nodes 406-1 through 406-4 controlling corresponding small cells 408-1 through 408-4. The low power nodes 406-1 through 406-4 can be small base stations (such as pico or femto base stations) or Remote Radio Heads (RRHs), or the like. Notably, while not illustrated, one or more of the small cells 408-1 through 408-4 may alternatively be provided by the base stations 402. The low power nodes 406-1 through 406-4 are generally referred to herein collectively as low power nodes 406 and individually as low power node 406. Likewise, the small cells 408-1 through 408-4 are generally referred to herein collectively as small cells 408 and individually as small cell 408. The cellular communications system 400 also includes a core network 410, which in the 5GS is referred to as the 5GC and in the EPS is referred to as the EPC. The base stations 402 (and optionally the low power nodes 406) are connected to the core network 410.

The base stations 402 and the low power nodes 406 provide service to wireless communication devices 412-1 through 412-5 in the corresponding cells 404 and 408. The wireless communication devices 412-1 through 412-5 are generally referred to herein collectively as wireless communication devices 412 and individually as wireless communication device 412. In the following description, the wireless communication devices 412 are oftentimes UEs and as such sometimes referred to herein as UEs 412, but the present disclosure is not limited thereto.

Example embodiments will now be described in detail. Embodiments of the present disclosure are based on the following aspects:
Setting up a dedicated bearer (i.e., a bearer with special properties) for carrying the QoE measurement report, or
Defining a new Protocol Data Unit (PDU) Type in “NR RAN Container” General Packet Radio Service (GPRS) Tunneling Protocol (GTP) User plane (GTP-U) extension header.

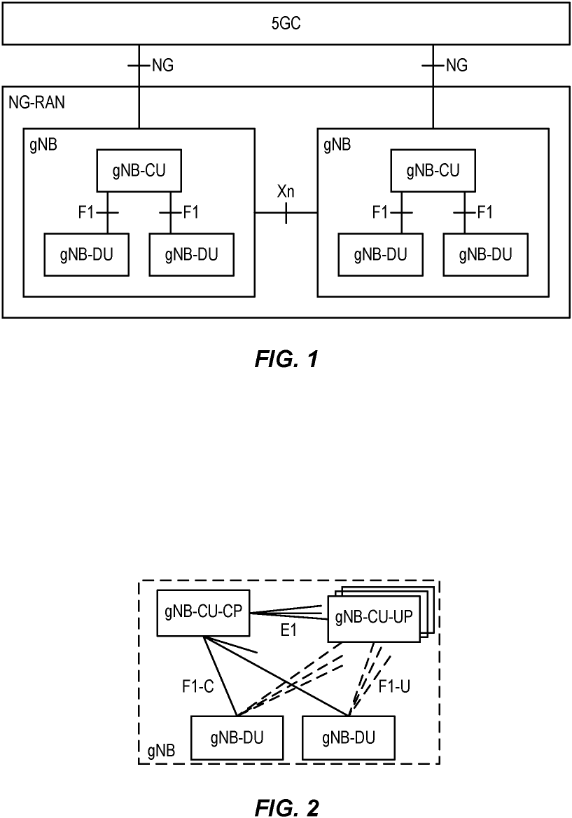

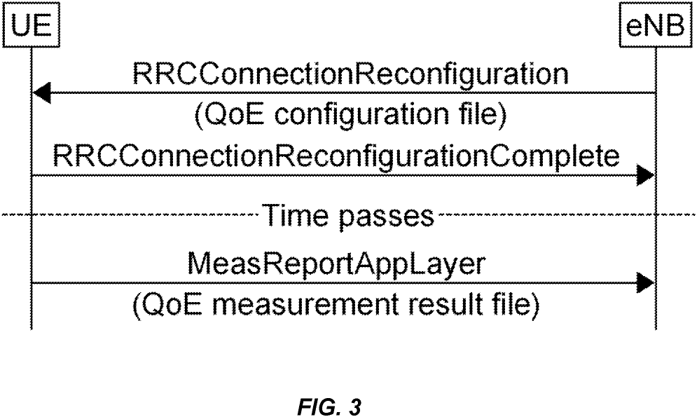

With respect to the NR RAN split architecture, described in the Background section above and illustrated in FIGS. 1 and 2, the E1 and F1 signaling aspects of the embodiments discussed below are only a non-limiting example. Having in mind that 3GPP has also standardized the LTE split architecture, the considerations below also apply to split LTE RAN and the corresponding interfaces therein (e.g., W1, E1′).

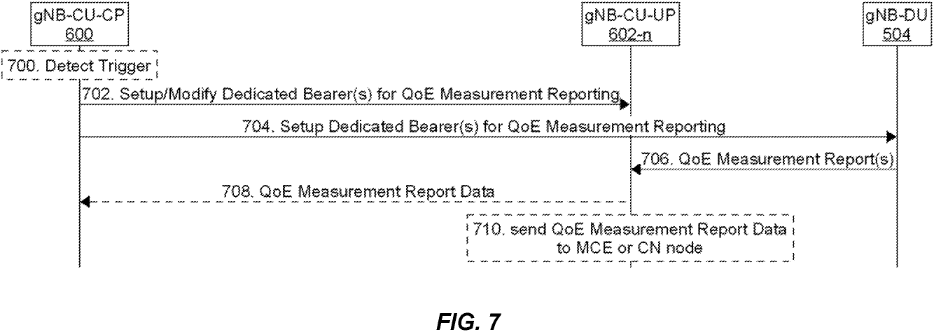

FIGS. 5 and 6 illustrate the NR RAN split architecture used for the following description. Again, a similar architecture applies for the LTE RAN split architecture and the embodiments disclosed herein are also applicable to the LTE RAN split architecture. As illustrated in FIG. 5, a gNB 500 includes a gNB-CU 502 and a number of gNB-DUs 504-1 and 504-2. Note that while two gNB-DUs 504 are illustrated, there may be any number of one or more gNB-DUs 504. As illustrated in FIG. 6, in the NR RAN split architecture, the gNB-CU 502 is split into a gNB-CU-CP 600 (i.e., a CP part) and a number of gNB-CU-UPs 602-1 through 602-N (i.e., UP parts), where N is an integer greater than or equal to 1. The gNB-CU-UPs 602-1 through 602-N are collectively referred to herein as gNB-CU-UPs 602. An individual gNB-CU-UP is referred to herein as a gNB-CU-UP 602-n.

### First Aspect: Carrying QoE Measurement Report On a Special/Dedicated UP Bearer

This aspect consists of F1 and E1 signaling.

### E1 Signaling

In case the gNB-CU 502 is split into gNB-CU-CP 600 and gNB-CU-UP(s) 602, the gNB-CU-CP 600 configures one or more special bearers at the gNB-CU-UP 602-n that are used for carrying the QoE measurement reports from a specific UE 412. This can be achieved by using the existing E1AP Bearer Context Setup and/or Bearer Context Modification (gNB-CU-CP initiated) procedures or by a new dedicated procedure.

In case the existing E1AP procedures are used, the existing bearer setup/modification messages are modified by including additional information to indicate that this bearer is to be used for report delivery (e.g., QoE measurement report delivery) and that it should receive special treatment. This additional information may include one or more of the following:
An explicit indication that this bearer is to be used for QoE report delivery, where the coupling between the bearer identity (ID) and its purpose is to be stored at gNB-CU-UP 602-n and used accordingly;
An explicit indication that this bearer is to be used for QoE report delivery. For example, this indication may be via a certain Data Radio Bearer (DRB) ID. Alternatively, the current DRB ID space (1-32) can be extended, where the DRBs carrying the QoE report would be assigned DRB IDs from the extended range;
An indication of whether this bearer can be used for carrying QoE reports of one QoE measurement session, or several different QoE measurement sessions, and a list of measurement session IDs whose reports can be carried on this bearer;
A configuration of special QoS attributes, defined for the purpose of QoE report delivery over UP;
A list of attributes, e.g., at DRB level, aiming to control the behavior of the gNB-CU-UP 602-n upon reception of at least one DRB used for QoE reporting, such as a flag to indicate an urgency condition (e.g., to distinguish between different types of QoE reporting), a level of priority, or the like;
A list of attributes, e.g., at DRB level, aiming to control the behavior of the gNB-CU-UP 602-n upon suspension of at least one DRB used for QoE reporting, such as a maximum time interval for which the bearer can be suspended;
A list of attributes, e.g., at DRB level, aiming to control the behavior of the gNB-CU-UP 602-n to, if needed, forward the data of at least one DRB used for QoE reporting to another CU-UP controlled by the same CU-CP.

In one embodiment, multiple QoE report bearers could be set up for the same UE 412, where different bearers would be used for different QoE report types (e.g., related to different services). One reason could be to associate different gNB-CU-UP behavior with different bearers, so that different report types get different treatment (e.g., forwarded to the gNB-CU-CP 600 or to the MCE). Another reason may be to give different QoE report bearers different QoS, e.g., depending on the type of report they carry. Then, this differentiation would be conveyed to the UE 412 as well. In one embodiment, the CN or O&M system not only provides the RAN with transparent QoE configuration to be forwarded to the UE 412, but also instructs the RAN on how many QoE report bearers it should set up and also provide an indication of what these bearers should carry so that the gNB-CU-CP 600 can signal the proper mapping between established bearers and which QoE report data is to be sent via which bearer.

In one embodiment, based on the above special bearer indication, the gNB-CU-UP 602-n operates to, upon receiving the data (i.e., the QoE measurement report) on this bearer, forward the data to the gNB-CU-CP 600. This can be achieved by using:
an existing UE-associated E1AP message (e.g., if the message carries reports pertaining to a single UE); or
an existing non-UE-associated E1AP message (e.g., if the message carries reports pertaining to more than one UE), containing the list of identifiers to distinguish between reports for different UEs (UE IDs) and/or the list of measurement session IDs to distinguish between different measurement reports for the same UE; or
a new non-UE-associated or UE-associated E1AP message.

Example motivations for forwarding the report to the gNB-CU-CP 600 may be e.g.:
to allow the RAN to reconfigure the resources, based on the QoE report; and/or
to allow the RAN to merge the reports received from several CU-UPs 602 (pertaining to one or several UEs 412), before forwarding the merged report to the MCE.

Alternatively, the gNB-CU-UP 602-n does not forward the reports to the gNB-CU-CP 600, but instead forwards the reports to the MCE or to a node in 5GC (e.g., UPF), e.g., by forwarding individual reports or by merging several reports of one or more measurement sessions from one or several UEs.

Alternatively, the gNB-CU-UP 602-n forwards the reports to the gNB-CU-CP 600, MCE, and/or to a node in 5GC (e.g., UPF), e.g., by forwarding individual reports or by merging several reports of one or more measurement sessions from one or several UEs (e.g., as list of QoE measurement reports).

In one embodiment, the dedicated bearer for carrying the measurement results may carry the QoE measurement configuration on the downlink and the measurement results on the uplink.

### F1 Signaling

After setting up the dedicated DRB at the gNB-CU-UP 602-n, the gNB-CU-CP 600 / gNB-CU 502 sets up resources at the gNB-DU 504 using F1AP signaling. This can be achieved by using the existing UE-associated F1AP procedures for UE context management, or by using a new dedicated F1AP procedure.

In case the existing F1AP procedures are used, the existing bearer setup/modification messages are modified by including additional information. This additional information may include:
· An explicit indication that this bearer is to be used for QoE report delivery, where the coupling between the bearer ID and its purpose is to be stored at the DU serving the UE and used accordingly;
· An explicit indication that this bearer is to be used for QoE report delivery. For example, via a certain DRB ID. Alternatively, the current DRB ID space (1-32) can be extended, where the DRBs carrying the QoE report would be assigned DRB IDs from the extended range;
· An indication of whether the dedicated bearer can be used for carrying QoE reports of one QoE measurement session, or several different measurement sessions, and a list of measurement session IDs whose reports can be carried on this bearer;
· A configuration of special QoS attributes, defined for the purpose of QoE report delivery over UP;
A list of attributes, e.g., at DRB level aiming to control the DU behavior upon reception of at least one DRB used for QoE reporting, such as a flag to indicate an urgency condition (e.g., to distinguish between different types of QoE reporting), a level of priority;
A list of attributes, e.g., at DRB level aiming to control the DU behavior upon suspension of at least one DRB used for QoE reporting, such as a maximum time interval for which the bearer can be suspended;
A list of attributes, e.g., at DRB level aiming to control the DU behavior to, if needed, forward the data of at least one DRB used for QoE reporting to another gNB-CU-UP controlled by the same gNB-CU-CP 600.

### Triggering of Dedicated Bearer Setup

The gNB-CU-CP 600 may set up the dedicated bearer:
As soon as it forwards the QoE measurement configuration to the UE 412;
For a selected UE, after selecting a suitable UE for a received management-based QoE measurement configuration signal from OAM;
After receiving a signaling/individual QoE measurement signal from OAM or AMF, for a particular UE;
After receiving an indication from the UE 412 that a report is ready to be delivered;
Based on a report availability indication from the UE 412, carried over the user plane (e.g., in DDDS defined in TS 38.425).

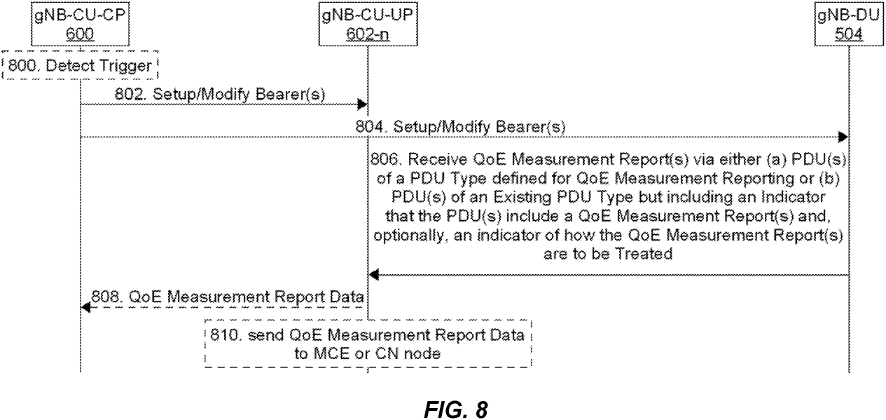

FIG. 7 illustrates the operation of the gNB-CU-CP 600, the gNB-CU-UP 602-n, and the gNB-DU 504 in accordance with the first aspect. Note that optional steps are represented by dashed lines/boxes. As illustrated, the gNB-CU-CP 600 detects a trigger for setting up a dedicated bearer(s) for QoE measurement reporting (step 700). The trigger may be any of the triggers described above for triggering of dedicated bearer setup. The gNB-CU-CP 600 (e.g., in response to detecting the trigger) sends one or more messages to the gNB-CU-UP 602-n to setup a dedicated bearer(s) for QoE measurement reporting (step 702). As described above in relation to the E1 signaling, these one or more messages include, in one embodiment, a bearer setup message or a bearer modification message that includes additional information (see above description for the details of this additional information). The gNB-CU-CP 600 also sends one or more messages to the gNB-DU 504 to setup the dedicated bearer(s) (step 704). As discussed above in relation to the F1 signaling, these one or more messages include, in one embodiment, a bearer setup message or a bearer modification messages that includes additional information (see above description for the details of this additional information).

After setup of the dedicated bearer(s) for QoE measurement reporting, the gNB-CU-UP 602-n receives QoE measurement report(s) via the dedicated bearer(s) (step 706). As discussed above, the gNB-CU-UP 602-n may then send QoE measurement report data to the gNB-CU-CP 600, an MCE or other CN node, or both the gNB-CU-CP 600 and an MCE or other CN node (steps 708 and 710). The QoE measurement report data may include, for example, the QoE measurement report(s) received by the gNB-CU-UP 602-n. For instance, the gNB-CU-UP 602-n may forward individual QoE measurement reports or merge several QoE measurement reports of one or more measurement sessions from one or several UEs (e.g., as list of QoE measurement reports) and forward the resulting merged data.

### Second Aspect: Carrying QoE Measurement Report in a New PDU Type

All considerations regarding report handling at gNB-CU-UP 602-n presented in the first aspect apply for the second aspect as well. The difference between the first and the second aspect is that, in the latter, the QoE measurement reports are carried on a regular DRB, but using a new PDU type defined for carrying QoE measurement reports. In other words, the DRB may carry both the existing PDU Types (e.g., those defined in 3GPP TS 38.425), and also the new PDU Type defined for QoE measurement report transfer. One motivation for defining a new PDU Type in “NR RAN Container” GTP-U extension header can be to ensure that the size of the report is not charged from the data plan.

Alternatively, an existing PDU type can be used, but a flag can be introduced to indicate that this PDU carries a QoE measurement report (or even multiple QoE measurement reports) in its payload. For instance, the existing PDU Type 1 or PDU Type 2 defined in TS 38.425 can be modified for this purpose, e.g. using one of the spare bits. As another option, multiple spare bits could be used to indicate not only that the PDU carries a QoE measurement report, but also instructions of how the gNB-CU-UP 602-n should treat the QoE measurement report, e.g. forward the QoE measurement report to the gNB-CU-CP 600, forward the QoE measurement report to the MCE or CN node, or forward the QoE measurement report to both the gNB-CU-CP 600 and the MCE or CN node.

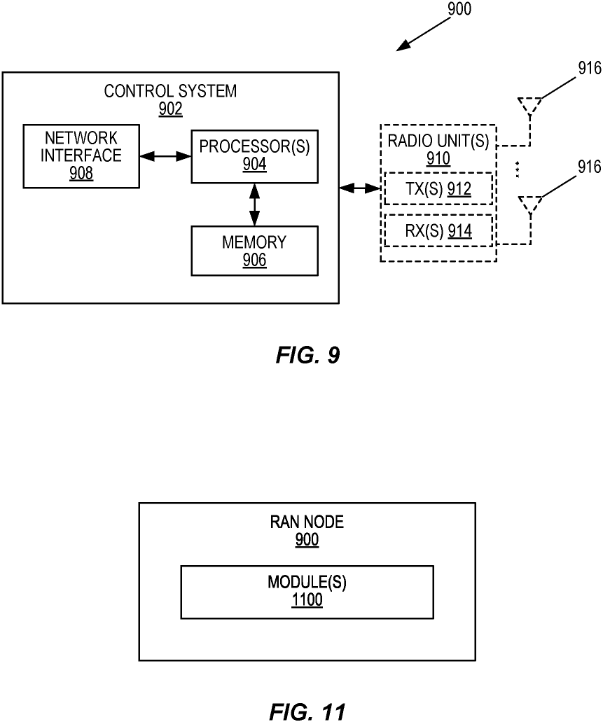

FIG. 8 illustrates the operation of the gNB-CU-CP 600, the gNB-CU-UP 602-n, and the gNB-DU 504 in accordance with the second aspect. Note that optional steps are represented by dashed lines/boxes. As illustrated, the gNB-CU-CP 600 detects a trigger for setting up a dedicated bearer(s) for QoE measurement reporting (step 800). The trigger may be any of the triggers described above in relation to the first aspect for triggering of dedicated bearer setup. The gNB-CU-CP 600 (e.g., in response to detecting the trigger) sends one or more messages to the gNB-CU-UP 602-n to setup a bearer(s) (step 802). Unlike in the first aspect, the bearer(s) here in the second aspect are not dedicated for QoE measurement reporting. In relation to the E1 signaling, these one or more messages include, in one embodiment, a bearer setup message or a bearer modification message. The gNB-CU-CP 600 also sends one or more messages to the gNB-DU 504 to setup the bearer(s) (step 804). In relation to the F1 signaling, these one or more messages include, in one embodiment, a bearer setup message or a bearer modification messages.

After setup of the bearer(s) for QoE measurement reporting, the gNB-CU-UP 602-n receives QoE measurement report(s) via PDU(s) over the bearer(s) (step 806). As discussed above, the PDU(s) may be of a PDU Type that is defined for QoE measurement reporting. Alternatively, the PDU(s) may be of a PDU type that is not dedicated to only QoE measurement reporting (e.g., an existing PDU type). In this case, in one embodiment, the PDU(s) include an indicator that the PDU includes one or more QoE measurement reports and, optionally, an indicator of how the gNB-CU-UP 602-n is to treat the QoE measurement report(s) carried on the PDU(s), as discussed above. As an example, one or more spare bits in each PDU may be used to indicate that the PDU carries one or more QoE measurement reports and, optionally, also indicate how the gNB-CU-CP 602-n is to treat the QoE measurement report(s) (e.g., forward the QoE measurement report(s) to the gNB-CU-CP 600, to an MCE or other CN node, or to both the gNB-CU-CP 600 and an MCE or other CN node.

As discussed above, the gNB-CU-UP 602-n may then send QoE measurement report data to the gNB-CU-CP 600, an MCE or other CN node, or both the gNB-CU-CP 600 and an MCE or other CN node (steps 808 and 810). The node(s) to which the gNB-CU-UP 602-n forwards the QoE measurement report data may be indicated in the received PDU(s), as discussed above. The QoE measurement report data may include, for example, the QoE measurement report(s) received by the xgNB-CU-UP 602-n. For instance, the gNB-CU-UP 602-n may forward individual QoE measurement reports or merge several QoE measurement reports of one or more measurement sessions from one or several UEs (e.g., as list of QoE measurement reports) and forward the resulting merged data.

### Example Realizations

### Example Related to the First Aspect

As a non-limiting example, the “QoE report” bearer indication can be included in the below E1AP Information Elements (IEs), used to setup or modify bearers at CU-UP. New aspects are bolded, underlined, and italicized (i.e., the new IE tentatively denoted “QoE Report Transfer”).

### PDU Session Resource To Setup List

This IE contains PDU session resource related information used at Bearer Context Setup Request (i.e. included in the Bearer Context Setup Request E1AP message from the gNB-CU-CP to the gNB-CU-UP).

| | | | | | | |
|---|---|---|---|---|---|---|
| IE/Group Name | Presence | Range | IE type and reference | Semantics description | Criticality | Assigned Criticality |
| PDU Session Resource To Setup Item | | 1.. <maxnoofPDUSessionReso urce> | | | - | - |
| >PDU Session ID | M | | 9.3.1.21 | | - | - |
| >PDU Session Type | M | | 9.3.1.22 | | - | - |
| >S-NSSAI | M | | 9.3.1.9 | | - | - |
| >Security Indication | M | | 9.3.1.23 | | - | - |
| >PDU Session Resource DL Aggregate Maximum Bit Rate | O | | Bit Rate 9.3.1.20 | This IE shall be present when at least one Non-GBR QoS Flows is being setup. | - | - |
| >NG UL UP Transport Layer Information | M | | UP Transport Layer Information 9.3.2.1 | | - | - |
| >PDU Session Data Forwarding Information Request | O | | Data Forwarding Information Request 9.3.2.5 | | - | - |
| >PDU Session Inactivity Timer | O | | Inactivity Timer 9.3.1.54 | Included if the Activity Notification Level is set to PDU Session. | - | - |
| >Existing Allocated NG DL UP Transport Layer Information | O | | UP Transport Layer Information 9.3.2.1 | | - | - |
| >Network Instance | O | | 9.3.1.62 | This IE is ignored if the Common Network Instance IE is included. | YES | ignore |
| >Common Network Instance | O | | 9.3.1.66 | | YES | ignore |
| >DRB To Setup List | | 1 | | | - | - |
| >>DRB To Setup Item | | 1.. <maxnoofDRBs> | | | - | - |
| >>>DRB ID | M | | 9.3.1.16 | | - | - |
| >>>SDAP Configura tion | M | | 9.3.1.39 | | - | - |
| >>>PDCP Configura tion | M | | 9.3.1.38 | | - | - |
| >>>Cell Group Information | M | | 9.3.1.11 | | - | - |
| >>>QoS Flows Information To Be Setup | M | | QoS Flow QoS Parameters List 9.3.1.25 | | - | - |
| >>>DRB Data forwarding information Request | O | | Data Forwarding Information Request 9.3.2.5 | Requesting forwarding info from the target gNB-CU- UP. | - | - |
| >>>DRB Inactivity Timer | O | | Inactivity Timer 9.3.1.54 | Included if the Activity Notification Level is set to DRB. | - | - |
| >>>PDCP SN Status Information | O | | 9.3.1.58 | Contains the PDCP SN Status at setup after Resume. | - | - |
| >>>DRB QoS | O | | 9.3.1.26 | Indicates the DRB QoS when more than one QoS Flow is mapped to the DRB. | YES | ignore |
| >>>QoE Report Transfer | O | | ENUMERAT ED (True. False....) | Indicates whether this bearer is to be used for carrying the QoE measurem ent report. | - | - |

| | |
|---|---|
| Range bound | Explanation |
| maxnoofDRBs | Maximum no. of DRBs for a UE. Value is 32. |
| maxnoofPDUSessionResource | Maximum no. of PDU Sessions for a UE. Value is 256. |

### PDU Session Resource To Modify List

This IE contains PDU session resource to modify related information used at Bearer Context Modification Request.

| E/Group Name | Presen ce | Range | IE type and reference | Semantics description | Criticali ty | Assign ed Criticali ty |
|---|---|---|---|---|---|---|
| PDU Session Resource To Modify Item | | 1.. <maxnoofPDUSessionReso urce> | | | - | - |
| >PDU Session ID | M | | 9.3.1.21 | | - | - |
| >Security Indication | O | | 9.3.1.23 | This IE is not used in this release. | - | - |
| >PDU Session Resource DL Aggregate Maximum Bit Rate | O | | Bit Rate 9.3.1.20 | | - | - |
| >NG UL UP Transport Layer Information | O | | UP Transport Layer Information 9.3.2.1 | | - | - |
| >PDU Session Data Forwarding Information Request | O | | Data Forwarding Information Request 9.3.2.5 | Requesting forwarding information from the target gNB-CU-UP. | - | - |
| >PDU Session Data Forwarding Information | O | | Data Forwarding Information 9.3.2.6 | Providing forwarding information to the source gNB-CU-UP. | - | - |
| >PDU Session Inactivity Timer | O | | Inactivity Timer 9.3.1.54 | Included if the Activity Notification Level is set to PDU Session. | - | - |
| >Network Instance | O | | 9.3.1.62 | This IE is ignored if the Common Network | YES | ignore |
| | | | | Instance IE is included. | | |
| >Common Network Instance | O | | 9.3.1.66 | | YES | ignore |
| >DRB To Setup List | | 0..1 | | | - | - |
| >>DRB To Setup Item | | 1.. <maxnoofDRBs> | | | - | - |
| >>>DRB ID | M | | 9.3.1.16 | | - | - |
| >>>SDAP Configuration | M | | 9.3.1.39 | | - | - |
| >>>PDCP Configuration | M | | 9.3.1.38 | | - | - |
| >>>Cell Group Information | M | | 9.3.1.11 | | - | - |
| >>>QoS Flow Information To Be Setup | M | | QoS Flow QoS Parameters List 9.3.1.25 | | - | - |
| >>>DRB Data Forwardin9 Information Request | O | | Data Forwarding Information Request 9.3.2.5 | Requesting forwarding information from the target gNB-CU-UP. | - | - |
| >>>DRB Inactivity Timer | O | | Inactivity Timer 9.3.1.54 | Included if the Activity Notification Level is set to DRB. | - | - |
| >>>PDCP SN Status Information | O | | 9.3.1.58 | Provides the PDCP SN Status at setup after Resume to the target gNB-CU-UP. | - | - |
| >>>DRB QoS | O | | 9.3.1.26 | Indicates the DRB QoS when more than one QoS Flow is mapped to the DRB | YES | ignore |
| >DRB To Modify List | | 0..1 | | | - | - |
| >>DRB To Modify Item | | 1.. <maxnoofDRBs> | | | - | - |
| >>>DRB ID | M | | 9.3.1.16 | | - | - |
| >>>SDAP Configuration | O | | 9.3.1.39 | | - | - |
| >>>PDCP Configuration | O | | 9.3.1.38 | | - | - |
| >>>DRB Data forwarding information | O | | Data Forwarding Information 9.3.2.6 | Providing forwarding information to the source gNB-CU-UP. | - | - |
| >>>PDCP SN Status Request | O | | ENUMERAT ED (requested, ...) | The gNB-CU-CP requests the gNB- CU-UP to provide the PDCP SN Status in the response message. | - | - |
| >>>PDCP SN Status Information | O | | 9.3.1.58 | Provides the PDCP SN Status to the target gNB-CU-UP. | - | - |
| >>>DL UP Parameters | O | | UP Parameters 9.3.1.13 | | - | - |
| >>>Cell Group To Add | O | | Cell Group Information 9.3.1.11 | | - | - |
| >>>Cell Group To Modify | O | | Cell Group Information 9.3.1.11 | | - | - |
| >>>Cell Group To Remove | O | | Cell Group Information 9.3.1.11 | | - | - |
| >>>Flow Mapping Information | O | | QoS Flow QoS Parameters List 9.3.1.25 | Overrides previous mapping information. | - | - |
| >>>DRB Inactivity Timer | O | | Inactivity Timer 9.3.1.54 | Included if the Activity Notification Level is set to DRB. | - | - |
| >>>Old QoS Flow List - UL End Marker expected | O | | QoS Flow List 9.3.1.12 | Indicates that the source NG-RAN node has initiated QoS flow re-mapping and has not yet received SDAP end markers, as described in TS 38.300 [8]. | YES | reject |
| >>>DRB QoS | O | | 9.3.1.26 | Indicates the DRB QoS when more than one QoS Flow is | YES | ignore |
| | | | | mapped to the DRB | | |
| >>>QoE Report Transfer | O | | ENUMERAT ED (True. False....) | Indicates whether this bearer is to be used for carrying the QoE measurem ent report. | | |
| >DRB To Remove List | | 0.. 1 | | | - | - |
| >>DRB To Remove Item | | 1.. <maxnoofDRBs> | | | - | - |
| >>>DRB ID | M | | 9.3.1.16 | | - | - |
| >S-NSSAI | O | | 9.3.1.9 | | YES | reject |

| | |
|---|---|
| Range bound | Explanation |
| maxnoofDRBs | Maximum no. of DRBs for a UE. Value is 32. |
| maxnoofPDUSessionResource | Maximum no. of PDU Sessions for a UE. Value is 256. |

Alternatively, the above IE bolded, underlined, and italicized (tentatively denoted “QoE Report Transfer”) may contain an indication of whether the DRB can be used for carrying the user data as well.

In another embodiment, the above IE bolded, underlined, and italicized (tentatively denoted “QoE Report Transfer) may be used to indicate if the QoE report transfer is paused or resumed.

In another embodiment, additional IEs may be used to indicate additional attributes related to the QoE report transfer such as priority, pre-emption capability, and pre-emption vulnerability.

In another embodiment, included in the above IE bolded, underlined, and italicized (tentatively denoted “QoE Report Transfer”), or in additional IEs complementing the QoE Report TransferIE, there may be information instructing the gNB-CU-UP 602-n whether QoE reports received on the DRB should be forwarded to the gNB-CU-CP 600 or the MCE. In a variant of this embodiment, the QoE report forwarding instruction could replace the previously proposed QoE Report Transfer IE. In such a case the QoE report instruction would, as one option, implicitly indicate that the bearer the QoE report forwarding instruction is associated with is used for sending of QoE reports, or, as another option, the QoE report instruction would implicitly indicate that QoE reports, but also other data, may be sent on the associated bearer. As yet another option, the QoE report forwarding instruction may include transport network layer (TNL) information for the QoE report forwarding, such as an IP address and possibly a UDP port number, TCP port number or SCTP port number or a GTP tunnel endpoint identifier. For instance, if the gNB-CU-CP includes a QoE report forwarding instruction indicating forwarding of QoE reports to the MCE, the QoE report forwarding instruction may include the IP address to forward the QoE reports to. Alternatively, the gNB-CU-UP may inherently know the required TNL information, e.g. based on configuration from the O&M system or when the gNB-CU-UP was deployed.

To support the above-described embodiment, where a QoE report forwarding instruction (e.g. forwarding of QoE reports to the gNB-CU-CP or the MCE) may be included in one of the E1AP message “Bearer Context Setup Request” or “Bearer Context Modification Request”, a gNB-CU-UP 602-n could indicate its support for different QoE report forwarding alternatives when the E1 interface is established, e.g. whether the gNB-CU-UP 602-n supports forwarding of QoE reports to the gNB-CU-CP 600 and/or the MCE. The gNB-CU-UP 602-n could, e.g., include this information in the E1AP message GNB-CU-CP E1 Setup Response or GNB-CU-UP E1 Setup Request.

In another embodiment, the QoE report forwarding instruction is not included in any of the of the above-described IEs or messages, but instead the gNB-CU-CP 600 instructs the gNB-CU-UP 602-n where to forward received QoE reports (e.g. to the gNB-CU-CP 600 or the MCE) when the E1 interface between the gNB-CU-CP 600 and the gNB-CU-UP 602-n is setup, e.g. in the GNB-CU-CP E1 Setup Request message or in the GNB-CU-UP E1 Setup Response message. This would then apply to all QoE reports the UE 412 receives. This may be combined with above-described embodiments where there is an IE in the Bearer Context Setup Request E1AP message and/or Bearer Context Modification Request E1AP message indicating that a certain bearer to be setup or modified is used to carry QoE reports. As one option, the QoE report forwarding instruction may later be updated using the E1AP message GNB-CU-CP Configuration Update. As one option, the QoE report forwarding instruction may include TNL information related to the entity (e.g., MCE) the QoE reports are to be forwarded to (as described above).

In another embodiment, another gNB-CU-UP behavior associated with a QoE bearer (i.e., a bearer (e.g., DRB) carrying QoE reports) that a gNB-CU-UP 602-n could be configured with is to store the received QoE reports until polled/requested by the gNB-CU-CP 600. This would give the gNB-CU-CP 600 better control of the processing resources devoted to handling QoE reports. For instance, if the gNB-CU-CP 600 is fully loaded with more time sensitive tasks, it can postpone requests for QoE reports stored at the gNB-CU-UP 602-n until the processing load is lower.

Yet another embodiment could be that the gNB-CU-UP 602-n can differentiate different type of QoE report data and give them different treatment, according to configuration/instructions from the gNB-CU-CP 600, e.g. forwarding different types of QoE report data to different entities or temporarily storing (until polled/requested by the gNB-CU-CP) one type but not another. One way to achieve this is that the gNB-CU-UP 602-n can parse the QoE report or identify predefined labels of different data types and give them different treatments. To allow later assembly or correlation between such divested parts of a QoE report, e.g. in the MCE or in the O&M system, they could all be labeled with the same identifier, e.g. a QoE report identifier. Another way to achieve differentiated treatment of different QoE report data types could be by establishing different QoE report bearers for different QoE report data types or different QoE report types (e.g., per application/service) and then associate different gNB-CU-UP behaviors with the different QoE report bearers.

### Example Related to Second Aspect

With respect to the second aspect, below is a non-limiting example where a flag is introduced into the existing PDU Type 1 from 3GPP TS 38.425, to indicate that the PDU carries the QoE report. The below example shows the GTP-U header only, so the example below depicts only the QoE Report Presence Flag. The field carrying the report itself (i.e., the payload part) is not shown. New aspects are bolded, underlined, and italicized.

### DL DATA DELIVERY STATUS (PDU Type 1)

This frame format is defined to transfer feedback to allow the receiving node (i.e. the node that hosts the NR PDCP entity) to control the downlink user data flow via the sending node (i.e. the corresponding node).

The following shows the respective DL DATA DELIVERY STATUS frame. The Figure shows an example of how a frame is structured when all optional IEs (i.e. those whose presence is indicated by an associated flag) are present.

Absence of such an IE changes the position of all subsequent IEs on octet level.

Figure 5.5.2.2–1

DL DATA DELIVERY STATUS (PDU Type 1) Format

| Bits | | | | | | | | Number of Octets |
|---|---|---|---|---|---|---|---|---|
| 7 | 6 | 5 | 4 | 3 | 2 | 1 | 0 | |
| PDU Type (=1) | | | | Highest Tranmitted NR PDCP SN Ind | Highest Delivered NR PDCP SN Ind | Final Frame Ind. | Lost Packet Report | 1 |
| Spare | | | QoE Report Presence Flag | Data rate Ind. | Retrans mitted NR PDCP SN Ind | Delivered Retransmitted NR PDCP SN Ind | Cause Report | 1 |
| Desired buffer size for the data radio bearer | | | | | | | | 4 |
| Desired Data Rate | | | | | | | | 0 or 4 |
| Number of lost NR-U Sequence Number ranges reported | | | | | | | | 0 or 1 |
| Start of lost NR-U Sequence Number range | | | | | | | | 0 or (6* Number of reported lost NR-U SN ranges) |
| End of lost NR-U Sequence Number range | | | | | | | | |
| Highest successfully delivered NR PDCP Sequence Number | | | | | | | | 0 or 3 |
| Highest transmitted NR PDCP Sequence Number | | | | | | | | 0 or 3 |
| Cause Value | | | | | | | | 0 or 1 |
| Successfully delivered retransmitted NR PDCP Sequence Number | | | | | | | | 0 or 3 |
| Retransmitted NR PDCP Sequence Number | | | | | | | | 0 or 3 |
| Padding | | | | | | | | 0-3 |

Other possibilities in conjunction with the above-described introduction of a new PDU type for QoE report transfer are to include various indications of how the gNB-CU-UP should handle the QoE report. This enables very dynamic treatments, e.g. per service, per QoE report type or even per QoE report, and the variety and flexibility of the different treatment options that could be indicated depends on how many bits that are used for the indications. One attractive way to introduce the indications in the frame would be to utilize 1, 2, or 3 of the spare bits in the frame, but it would also be possible to introduce one or more additional octet(s) for this purpose. To support and even extend the indication possibilities with such dynamic QoE report treatment indications, rules for which treatment a QoE report with a certain treatment indication (i.e., a certain combination of bit value(s)) should receive (i.e., with other words, rules associating treatment indicator values with treatments) would have to be provided to the gNB-CU-UP 602-n. Such rules could be provisioned via standardization (i.e., hardcoded in standard specification(s)) or configured by the gNB-CU-CP 600. Configuration by the gNB-CU-CP 600 could be performed when the E1 interface towards the gNB-CU-UP 602-n is established, e.g. in the GNB-CU-CP E1 Setup Request message or in the GNB-CU-UP E1 Setup Response message. Alternatively, providing even more dynamics and flexibility, the gNB-CU-CP 600 could send the rules to the gNB-CU-UP 602-n together with the request to establish a bearer on which QoE reports may be sent, e.g. included in the Bearer Context Setup Request message or the Bearer Context Modification Request message, e.g. as a part of or in addition to the previously described new IE(s). In addition to configuring the gNB-CU-UP 600, the UE 412 has to be enabled to know how to set the QoE report treatment indicators when it sends QoE reports to the gNB-CU-UP 602-n. This may be based on predefined rules, which could be specified in a standard specification or configured via the system information broadcast in each cell or via dedicated signaling to each UE for which this type of configuration is relevant. As one option, the QoE indicator setting rules could be signaled to the UE when the QoE measurements are configured, e.g. as a part of the QoE measurement configuration. A simpler way would be to set up multiple QoE bearers with different associated settings of the QoE report treatment indicator, possibly also associated with different measured services/applications or different QoE measurement configurations.

### Additional Description

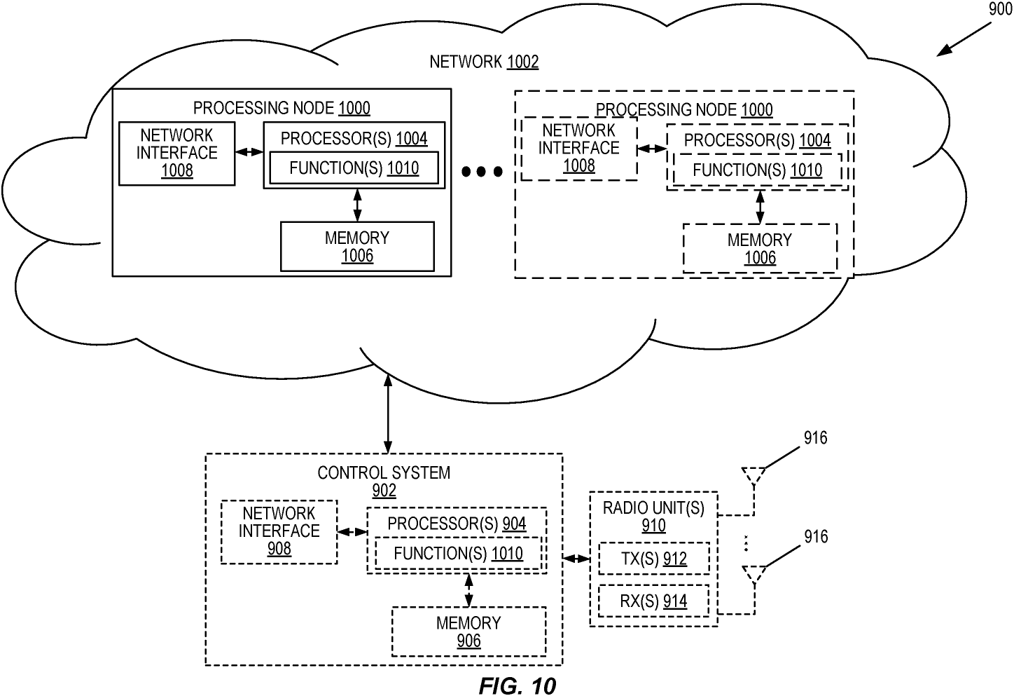

FIG. 9 is a schematic block diagram of a RAN node 900 according to some embodiments of the present disclosure. Optional features are represented by dashed boxes. The RAN node 900 may be, for example, a base station 402 or 406 or a network node that implements all or part of the functionality of the base station 402 or gNB described herein (e.g., implements the gNB-CU 502, gNB-DU 504, gNB-CU-CP 600, or gNB-CU-UP 602-n). As illustrated, the RAN node 900 includes a control system 902 that includes one or more processors 904 (e.g., Central Processing Units (CPUs), Application Specific Integrated Circuits (ASICs), Field Programmable Gate Arrays (FPGAs), and/or the like), memory 906, and a network interface 908. The one or more processors 904 are also referred to herein as processing circuitry. In addition, the RAN node 900 may include one or more radio units 910 that each includes one or more transmitters 912 and one or more receivers 914 coupled to one or more antennas 916. The radio units 910 may be referred to or be part of radio interface circuitry. In some embodiments, the radio unit(s) 910 is external to the control system 902 and connected to the control system 902 via, e.g., a wired connection (e.g., an optical cable). However, in some other embodiments, the radio unit(s) 910 and potentially the antenna(s) 916 are integrated together with the control system 902. The one or more processors 904 operate to provide one or more functions of the RAN node 900 as described herein (e.g., one or more functions of the gNB-CU 502, gNB-DU 504, gNB-CU-CP 600, or gNB-CU-UP 602-n described above, e.g., with respect to FIG. 7 or FIG. 8). In some embodiments, the function(s) are implemented in software that is stored, e.g., in the memory 906 and executed by the one or more processors 904.

FIG. 10 is a schematic block diagram that illustrates a virtualized embodiment of the RAN node 900 according to some embodiments of the present disclosure. This discussion is equally applicable to other types of network nodes. Further, other types of network nodes may have similar virtualized architectures. Again, optional features are represented by dashed boxes.

As used herein, a “virtualized” RAN node is an implementation of the RAN node 900 in which at least a portion of the functionality of the RAN node 900 is implemented as a virtual component(s) (e.g., via a virtual machine(s) executing on a physical processing node(s) in a network(s)). As illustrated, in this example, the RAN node 900 may include the control system 902 and/or the one or more radio units 910, as described above. The control system 902 may be connected to the radio unit(s) 910 via, for example, an optical cable or the like. The radio access node 900 includes one or more processing nodes 1000 coupled to or included as part of a network(s) 1002. If present, the control system 902 or the radio unit(s) are connected to the processing node(s) 1000 via the network 1002. Each processing node 1000 includes one or more processors 1004 (e.g., CPUs, ASICs, FPGAs, and/or the like), memory 1006, and a network interface 1008.

In this example, functions 1010 of the RAN node 900 described herein (e.g., one or more functions of the gNB-CU 502, gNB-DU 504, gNB-CU-CP 600, or gNB-CU-UP 602-n described above, e.g., with respect to FIG. 7 or FIG. 8) are implemented at the one or more processing nodes 1000 or distributed across the one or more processing nodes 1000 and the control system 902 and/or the radio unit(s) 910 in any desired manner. In some particular embodiments, some or all of the functions 1010 of the RAN node 900 described herein are implemented as virtual components executed by one or more virtual machines implemented in a virtual environment(s) hosted by the processing node(s) 1000. As will be appreciated by one of ordinary skill in the art, additional signaling or communication between the processing node(s) 1000 and the control system 902 is used in order to carry out at least some of the desired functions 1010. Notably, in some embodiments, the control system 902 may not be included, in which case the radio unit(s) 910 communicate directly with the processing node(s) 1000 via an appropriate network interface(s).

In some embodiments, a computer program including instructions which, when executed by at least one processor, causes the at least one processor to carry out the functionality of the RAN node 900 or a node (e.g., a processing node 1000) implementing one or more of the functions 1010 of the RAN node 900 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 11 is a schematic block diagram of the RAN node 900 according to some other embodiments of the present disclosure. The RAN node 900 includes one or more modules 1100, each of which is implemented in software. The module(s) 1100 provide the functionality of RAN node 900 described herein (e.g., one or more functions of the gNB-CU 502, gNB-DU 504, gNB-CU-CP 600, or gNB-CU-UP 602-n described above, e.g., with respect to FIG. 7 or FIG. 8). This discussion is equally applicable to the processing node 1000 of FIG. 10 where the modules 1100 may be implemented at one of the processing nodes 1000 or distributed across multiple processing nodes 1000 and/or distributed across the processing node(s) 1000 and the control system 902.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1. A method performed in a Radio Access Network, RAN, having a distributed RAN architecture, the method comprising:
at a control plane part of a central unit, CU-CP, of a base station of the RAN:
sending one or more first messages to a user plane part of the central unit, CU-UP, to setup or modify one or more bearers;
sending one or more second message to a distributed unit, DU, of the base station to setup or modify the one or more bearers;
at the CU-UP:
receiving the one or more first messages from the CU-CP;
at the DU:
receiving the one or more second messages;
sending one or more Quality of Experience, QoE, measurement reports to the CU-UP via the one or more bearers;
at the CU-UP:
receiving the one or more QoE measurement reports from the DU; and
forwarding the one or more QoE measurement reports to the CU-CP, another network node, or both the CU-CP and another network node.

2. The method of claim 1 wherein the one or more bearers are one or more bearers that are dedicated for QoE measurement reporting.

3. The method of claim 1 wherein the one or more bearers are not dedicated for QoE measurement reporting.

4. The method of claim 3 wherein receiving the one or more QoE measurement reports at the CU-UP comprises receiving the one or more QoE measurement reports at the CU-UP via one or more Protocol Data Units, PDUs, of a PDU type that is dedicated for QoE measurement reporting.

5. The method of claim 3 wherein receiving the one or more QoE measurement reports at the CU-UP comprises receiving the one or more QoE measurement reports at the CU-UP via one or more Protocol Data Units, PDUs, of a PDU type that is not dedicated for QoE measurement reporting.

6. The method of claim 5 wherein the one or more PDUs comprise an indication that the one or more PDUs comprise one or more QoE measurement reports.

7. The method of claim 4 wherein the one or more PDUs comprise an indication of how the one or more QoE measurement reports are to be treated by the CU-UP.

8. The method of claim 4 wherein the one or more PDUs comprise an indication of whether the CU-UP is to forward the one or more QoE measurement reports to the CU-CP, another network node, or both the CU-CP and another network node.

9. A method performed by a control plane part of a central unit, CU-CP, of a base station of a Radio Access Network, RAN, having a distributed RAN architecture, the method comprising:
sending one or more first messages to a user plane part of the central unit, CU-UP, to setup or modify one or more bearers that are dedicated for Quality of Experience, QoE, measurement reporting.

10. The method of claim 9 wherein the one or more first messages comprise a bearer setup message or a bearer modification message for a respective bearer from among the one or more bearers, the bearer setup message or the bearer modification message comprising:
a) an indication that the respective bearer is to be used for QoE measurement reporting;
b) an indication that the respective bearer is to be used for carrying QoE measurement reports of a particular QoE measurement session;
c) an indication that the respective bearer is to be used for carrying QoE measurement reports of a number of QoE measurement sessions;
d) an indication of whether the respective bearer can be used for carrying QoE measurement reports of one or more QoE measurement sessions identified in a list of QoE measurement session identities, IDs;
e) a configuration of one or more Quality of Service, QoS, attributes defined for QoE report delivery over user plane;
f) one or more attributes that control behavior of the CU-UP upon reception of data on the respective bearer used for QoE measurement reporting;
g) one or more attributes that control the behavior of the CU-UP upon suspension of the respective bearer used for QoE measurement reporting;
h) one or more attributes that control the behavior of the CU-UP to, if needed, forward data of the respective bearer used for QoE measurement reporting to another CU-UP controlled by the same CU-CP; or
i) a combination of any two or more of (a) - (h).

11. The method of claim 9 further comprising sending one or more second messages to a distributed unit, DU, of the base station to setup or modify the one or more bearers that are dedicated for QoE measurement reporting.

12. The method of claim 11 wherein the one or more second messages comprise a bearer setup message or a bearer modification message for a respective bearer from among the one or more bearers, the bearer setup message or the bearer modification message comprising:
i. an indication that the respective bearer is to be used for QoE measurement reporting;
ii. an indication that the respective bearer is to be used for carrying QoE measurement reports of a particular QoE measurement session;
iii. an indication that the respective bearer is to be used for carrying QoE measurement reports of a number of QoE measurement sessions;
iv. an indication that the respective bearer is to be used for carrying QoE measurement reports of one or more QoE measurement sessions identified in a list of QoE measurement session identities, IDs;
v. a configuration of one or more Quality of Service, QoS, attributes defined for QoE report delivery over user plane;
vi. one or more attributes that control behavior of the DU upon reception of data on the respective bearer used for QoE measurement reporting;
vii. one or more attributes that control the behavior of the DU upon suspension of the respective bearer used for QoE measurement reporting;
viii. one or more attributes that control the behavior of the DU to, if needed, forward data of the respective bearer used for QoE measurement reporting to another CU-UP controlled by the same CU-CP ; or
ix. a combination of any two or more of (i) - (viii).

13-26. (canceled)

27. A Radio Access Network, RAN, node that implements a control plane part of a central unit, CU-CP, of a base station of a Radio Access Network, RAN, having a distributed RAN architecture, the RAN node comprising:
a communication interface ; and
processing circuitry associated with the communication interface, the processing circuitry configured to cause the RAN node to send one or more first messages to a user plane part of the central unit, CU-UP, to setup or modify one or more bearers that are dedicated for Quality of Experience, QoE, measurement reporting.

28. (canceled)

29. A method performed by a user plane part of a central unit, CU-UP, of a base station of a Radio Access Network, RAN, having a distributed RAN architecture, the method comprising:
receiving one or more first messages from a control plane part of the central unit, CU-CP, to setup or modify one or more bearers that are dedicated for Quality of Experience, QoE, measurement reporting.

30. The method of claim 29 wherein the one or more first messages comprise a bearer setup message or a bearer modification message for a respective bearer from among the one or more bearers, the bearer setup message or the bearer modification message comprising:
a) an indication that the respective bearer is to be used for QoE measurement reporting;
b) an indication that the respective bearer is to be used for carrying QoE measurement reports of a particular QoE measurement session;
c) an indication that the respective bearer is to be used for carrying QoE measurement reports of a number of QoE measurement sessions;
d) an indication of whether the respective bearer can be used for carrying QoE measurement reports of one or more QoE measurement sessions identified in a list of QoE measurement session identities, IDs;
e) a configuration of one or more Quality of Service, QoS, attributes defined for QoE report delivery over user plane;
f) one or more attributes that control behavior of the CU-UP upon reception of data on the respective bearer used for QoE measurement reporting;
g) one or more attributes that control the behavior of the CU-UP upon suspension of the respective bearer used for QoE measurement reporting;
h) one or more attributes that control the behavior of the CU-UP to, if needed, forward data of the respective bearer used for QoE measurement reporting to another CU-UP controlled by the same CU-CP; or
i) a combination of any two or more of (a) - (h).

31. The method of claim 29 further comprising:
receiving one or more QoE measurement reports from a distributed unit, DU, of the base station via at least one of the one or more bearers that are dedicated for QoE measurement reporting; and
forwarding the one or more QoE measurement reports to the CU-CP, another network node, or both the CU-CP and another network node.

32. The method of claim 31 wherein forwarding the one or more QoE measurement reports comprises forwarding the one or more QoE measurement reports via:
one or more wireless-communication-device-associated messages; or
one or more non-wireless-communication-device-associated messages each comprising a list of identifiers that distinguishes between QoE measurement reports for different wireless communication devices and/or a list of measurement session identifiers that distinguishes between QoE measurement reports for a same wireless communication device.

33. The method of claim 31 wherein the CU-UP stores the one or more QoE measurement reports, and forwarding the one or more QoE measurement reports comprises forwarding the one or more QoE measurement reports to the CU-CP responsive to a request from the CU-CP.

34-46. (canceled)

47. A Radio Access Network, RAN, node that implements a user plane part of a central unit, CU-UP, of a base station of a Radio Access Network, RAN, having a distributed RAN architecture, the RAN node comprising:
a communication interface and
processing circuitry associated with the communication interface the processing circuitry configured to cause the RAN node to receive one or more first messages from a control plane part of the central unit, CU-CP, to setup or modify one or more bearers that are dedicated for Quality of Experience, QoE, measurement reporting.

48-62. (canceled)
